(19) United States
(12) Patent Application Publication
(10) Pub. No.: US 2009/0126329 A1
(43) Pub. Date: May 21, 2009

(54) Reel Weed Cutterhead

(76) Inventor: Michael D. Mills, Glendive, MO (US)

Correspondence Address: JEAN KYLE, P. O. BOX 2274, HAMILTON, MT, 59840-4274, US

(21) Appl. No.: 12/274,179

(22) Filed: Nov. 19, 2008

Related U.S. Application Data
(60) Provisional application No. 61/003,665, filed on Nov. 19, 2007.

(51) Int. Cl. A01D 34/53; A01D 75/08

(52) U.S. Cl. 56/249; 56/250

(57) ABSTRACT

A reel weed cutterhead to cut aquatic vegetation has a shroud supporting cutting reels and bed knives. The reels have helical blades that cut vegetation parallel to the axis of rotation of the reel. The reels and bed knives work together to cleanly shear aquatic weeds. The shroud contains the weeds for disposal by a centrifugal pump.

### CROSS-REFERENCE TO RELATED APPLICATIONS

This application claims the benefits of U.S. Provisional Application No. 61/003,665, filed Nov. 19, 2007, the disclosure of which is hereby incorporated by reference in its entirety including all figures, tables and drawings.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Cutting weeds underwater can be a complicated process. Many cutting blades accumulate cut weeds which foul the blades preventing them from shearing effectively. Rotating cutters that rotate too quickly can pulverize weeds which then reseed and propagate the weeds. Weed cutter have been designed in an attempt to address these problems (see for example, U.S. Pat. Nos. 3,238,708; 3,866,396; 4,202,155; 4,583,353; and 7,334,358 B1). Complicated systems of intermeshing cutterhead teeth and blades have been described (U.S. Pat. Nos. 3,971,148; and 5,481,856) to try to prevent fouling of aquatic cutterheads.

A need remains for an effective aquatic weed cutter that efficiently shears weeds cleanly to allow them to be quickly removed from the area.

All patents, patent applications, provisional patent applications and publications referred to or cited herein, are incorporated by reference in their entirety to the extent they are not inconsistent with the teachings of the specification.

### BRIEF SUMMARY OF THE INVENTION

A reel weed cutterhead cuts aquatic vegetation for removal by a centrifugal pump. The cutterhead has a shroud supporting a reel with helical blades. The helical blades shear the length of the helical edge providing more cutting area. A bed knife also mounted on the shroud works in association with the blades on the reel to shear the aquatic vegetation.

### BRIEF DESCRIPTION OF THE SEVERAL VIEWS OF THE DRAWING

FIG. 1 is a front isometric view of a preferred embodiment of the reel weed cutterhead of the subject invention.

FIG. 2 is a rear isometric view of a preferred embodiment of the reel weed cutterhead of the subject invention.

FIG. 3 is a front top perspective view of a preferred embodiment of the reel weed cutterhead of the subject invention.

FIG. 4 is a rear top perspective view a preferred embodiment of the reel weed cutterhead of the subject invention.

### DETAILED DESCRIPTION OF THE INVENTION

The reel weed cutterhead of the subject invention is preferably used to cut aquatic vegetation for removal by a centrifugal pump. In a preferred embodiment, the cutterhead is mounted on a dredging frame or other piece of equipment which facilitates its use in areas of aquatic weed growth.

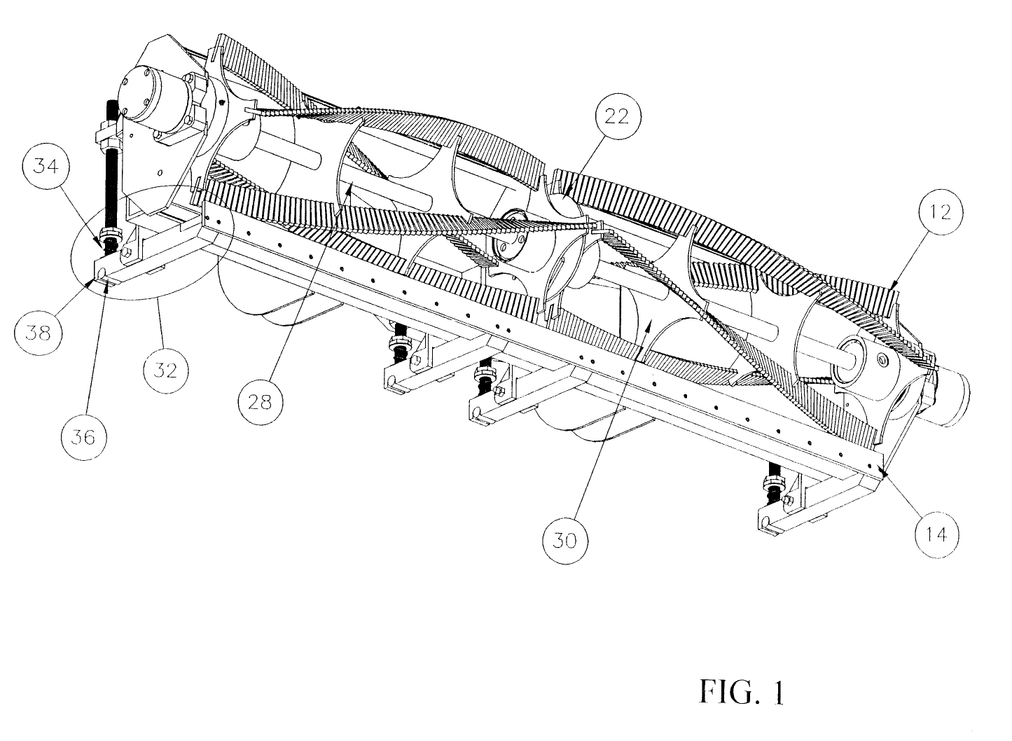

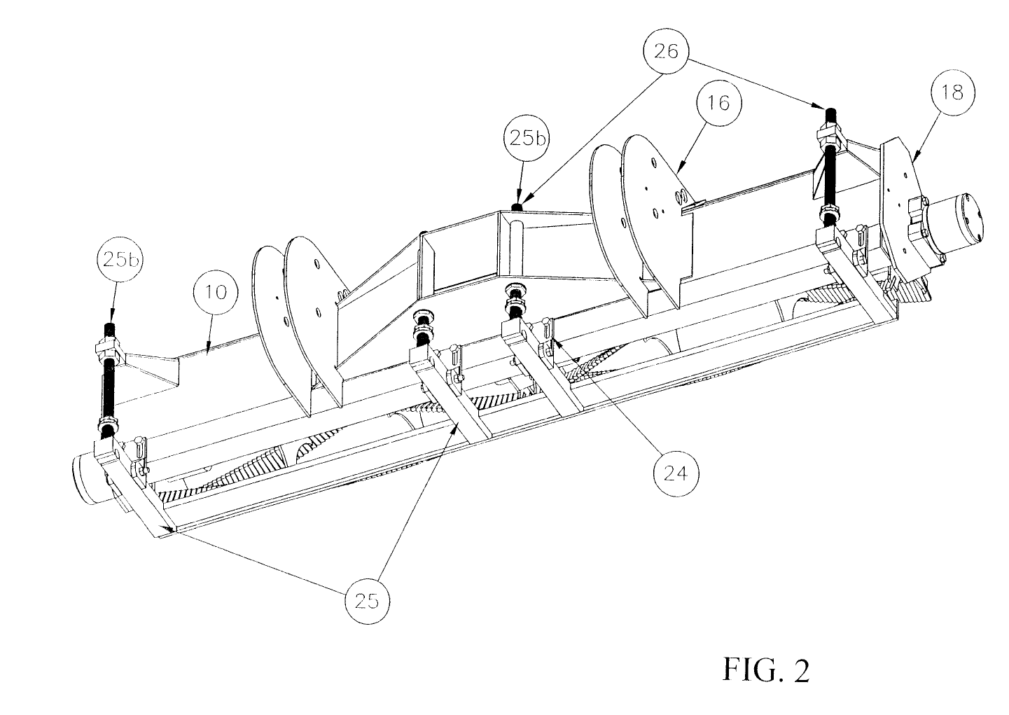

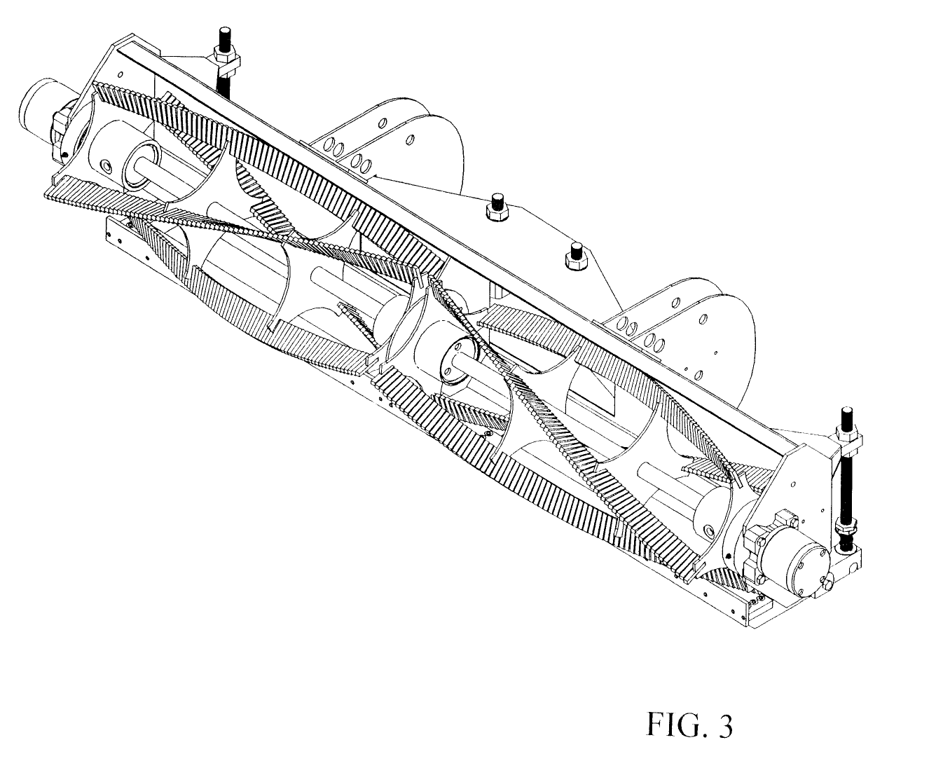

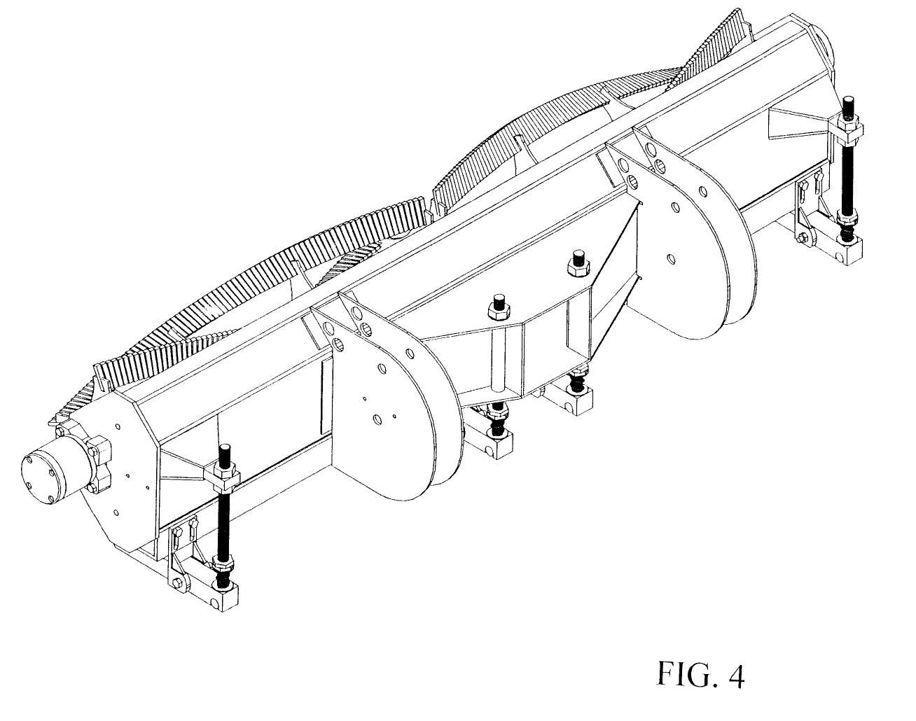

A preferred embodiment of the reel weed cutterhead is shown in FIGS. 1-4. The cutterhead comprises a shroud 10, at least one reel 12, and bed knives 14. The shroud 10 serves as the structural backbone of the cutterhead. The shroud has a mounting apparatus 16 attached to it that mounts the cutterhead to the equipment that will be positioning it. The shroud should be constructed to provide adequate strength to support the cutterhead. In a preferred embodiment, the shroud is constructed of 11 gauge A36 steel. The shroud also contains the vegetation after cutting and is the transition agent to send the cut vegetation to the centrifugal pump. Mounts 18 to engage the ends of the reels 12 are affixed to the shroud 10. In the exemplified embodiment, the cutterhead has two reels. Each end of the shroud mounts one end of each reel. The center of the shroud has a mount(s) for the center bearing support(s) 22 which supports the other end of each reel. Course vertical adjustment brackets 24 for positioning of the bed knife bar(s) 14 are mounted to the bottom of the shroud. In a preferred embodiment, there are two course vertical adjustment bars 25 per each of the two bed knife bars. Fine adjustment rods 26 are mounted to the shroud also. In the exemplified embodiment, the outermost course adjustment bars 25a are held in position on the enclosure at the top of each end by a hole bored through a piece of rectangular stock on the rear of the shroud. The innermost adjustment bars 25b are held in position by running them through the dispersion chamber at the center and rear of the shroud.

The reels 12 are the rotating element(s) that pull the vegetation in to be cut, cut the vegetation, and transition the cut vegetation for removal by the pump. The reels preferably comprise hardened steel blades twisted in a partial helix that rotate at a variable revolutions per minute. Blades rather than teeth are a preferred cutting means since teeth can catch vegetation which can become wrapped around the fixed portions of the cutterhead. In contrast to spiral blades which cut perpendicular to the axis of rotation, the helical blades of the subject invention shear parallel to the rotational axis of the reel. The helical configuration presents a full cutting edge along the entire axis of rotation of the reel. The fuller cutting edge shears vegetation more efficiently. The reels of the subject invention are driven and structurally supported by a shaft 28 through their center to keep the units concentric along the length of the shroud. Spiders or steel plates 30 connect the shaft to the hardened helix blades. The reels are driven hydraulically, either directly or remotely on one or both ends, depending on the required cutting force. If only a single end drive is required the opposite end is supported using a product lubricated bearing. Blades and teeth of aquatic vegetation harvesters are sometimes supported by a smooth drum to prevent vegetation from fouling the head. The open configuration of the helical blades of the cutterhead of the subject invention allows sheared weeds to pass to the pump for removal.

The bed knives 14 are also directly involved in shearing vegetation. In a preferred embodiment, the bed knives are hardened steel bars mounted on an adjustable lever assembly 32 that is affixed to the shroud. The number of bed knives required depends upon the number of reels employed. Bed knives are replaceable and need to be adjusted so contact is continuous along the length of the blades on the reels. The bed knife(s) have emergency reliefs built into the bed knife bar adjustment assembly. In the exemplified embodiment, the assembly is spring loaded to allow the bed knife reel clearance to open if an un-shearable item is encountered. This reduces the chance for damage occurring to the reels(s) or bed knife(s). The emergency relief spring 34 is mounted around a T-bolt 36 that fits through a slot 38 in the bed knife adjustment assembly lever arm 32. The spring is tensioned by threading the T-bolt into the fine adjustment rods.

Adjustment of the reel to the bed knife needs to be carefully monitored. Course adjustment is used to get the unit operating and fine adjustment optimizes performance. Insufficient contact of the clearance will cause poor performance. Too tight of contact between the bedknife(s) and the reel(s) will stop all rotation and damage may occur. Initial clearance is to be set using a procedure called back lapping. The reel(s) are rotated in reverse and coated with an abrasive lapping compound. The bed knives are adjusted toward the reels one end at a time until light contact occurs. Once both ends have been adjusted to light contact the bars can be slowly adjusted until contact occurs across the entire length of the reel(s) and bed knife bar(s). Once a continuous path is achieved the assembly can be cleaned of lapping compound and is ready for service.

It is understood that the foregoing examples are merely illustrative of the present invention. Certain modifications of the articles and/or methods may be made and still achieve the objectives of the invention. Such modifications are contemplated as within the scope of the claimed invention.

1. A cutterhead for cutting aquatic vegetation comprising:
at least one stationary bed knife;
a shroud supporting the at least one stationary bed knife;
at least one horizontally disposed reel rotationally mounted in the shroud, the at least one reel comprising at least one blade helically disposed about a central shaft, and connecting means connecting the at least one blade to the shaft in a spaced apart relationship; and
means to position the at least one bed knife adjacent the at least one reel to shear aquatic vegetation.

2. The cutterhead of claim 1, wherein said cutterhead comprises two reels and said shroud has a center support.

3. The cutterhead of claim 1, wherein said cutterhead comprises two reels and two bed knives.

4. The cutterhead of claim 1, wherein said reels are driven to rotate by at least one end.

5. The cutterhead of claim 1, wherein each of said at least one reels comprises four blades.

6. The cutterhead of claim 1, wherein said connecting means are plates.

7. The cutterhead of claim 1, wherein said means to position the at least one bed knife comprises at least one course adjustment means and at least one fine adjustment means.

8. The cutterhead of claim 1, wherein said means to position the at least one bed knife comprises an adjustable lever arm.

9. The cutterhead of claim 1, wherein said means to position the at least one bed knife comprises a spring-loaded adjustable lever arm.

10. The cutterhead of claim 1, wherein said shroud comprises a center dispersion chamber for connection to a pump.

11. A method of cutting aquatic vegetation comprising the steps of:
a) coating at least one reel of a cutterhead comprising at least one stationary bed knife, a shroud supporting the at least one stationary bed knife, at least one horizontally disposed reel rotationally mounted in the shroud, the at least one reel comprising at least one blade helically disposed about a central shaft, and connecting means connecting the at least one blade to the shaft in a spaced apart relationship, and means to position the at least one bed knife adjacent the at least one reel to shear aquatic vegetation;
b) rotating the at least one reel in reverse;
c) adjusting the means to position the at least one bed knife until light contact occurs across the entire length of the at least one reel and at least one bed knife;
d) cleaning the lapping compound from the at least one reel; and
e) rotating the at least one reel forward to shear aquatic vegetation.

12. The method of claim 11, wherein said cutterhead comprises two reels and said shroud has a center support.

13. The method of claim 11, wherein said cutterhead comprises two reels and two bed knives.

14. The method of claim 11, wherein said reels are driven to rotate by at least one end.

15. The method of claim 11, wherein each of said at least one reels comprises four blades.

16. The method of claim 11, wherein said connecting means are plates.

17. The method of claim 11, wherein said means to position the at least one bed knife comprises at least one course adjustment means and at least one fine adjustment means.

18. The method of claim 11, wherein said means to position the at least one bed knife further comprises a means to release the knife if it encounters an unshearable item.

19. The method of claim 11, wherein said shroud comprises a center dispersion chamber for connection to a pump.

20. A cutterhead for cutting aquatic vegetation comprising:
two stationary bed knives;
a shroud supporting the stationary bed knife;
two horizontally disposed reels rotationally mounted in the shroud, the two reels comprising four blades helically disposed about a central shaft, and plates connecting the four blades to the shaft in a spaced apart relationship from the shaft; and
means to position the two bed knives adjacent the two reels to shear aquatic vegetation.
